(19) United States
(12) Patent Application Publication
(10) Pub. No.: US 2013/0271575 A1
(43) Pub. Date: Oct. 17, 2013

(54) Dynamically Controlling an Imaging Microscopy System

(71) Applicant: ZSPACE, INC., Sunnyvale, CA (US)

(72) Inventor: Peter F. Ullmann, San Jose, CA (US)

(73) Assignee: ZSPACE, INC., Sunnyvale, CA (US)

(21) Appl. No.: 13/838,571

(22) Filed: Mar. 15, 2013

Related U.S. Application Data
(60) Provisional application No. 61/622,811, filed on Apr. 11, 2012.

(51) Int. Cl. H04N 13/02

(52) U.S. Cl. CPC H04N 13/02
USPC 348/46

(57) ABSTRACT

System and method for controlling an imaging microscopy system (IMS). A control module may be coupled to an IMS configured to capture an image of a specified region of a specimen based on a specified perspective by controlling the specimen's position and/or orientation relative to an image capture subsystem of the IMS corresponding to the specified perspective. A 6 DOF tracker may detect position and/or orientation of a 6 DOF object with respect to a display of the IMS corresponding to a perspective for image capture of the specimen, and send indicative information thereof to the control module, which may determine the specified perspective based on the information, and may determine the specified region of the specimen for image capture based on the specified perspective. The control module may send information indicating the specified region and perspective to the IMS, thereby controlling capture of the image by the IMS.

### PRIORITY DATA

This application claims benefit of priority to U.S. Provisional Application Ser. No. 61/622,811, titled “Integrate Head Track To Optical Inspection System”, filed Apr. 11, 2012, whose inventor was Peter F. Ullmann, which is hereby incorporated by reference in its entirety as though fully and completely set forth herein.

### TECHNICAL FIELD

This disclosure relates to the field of digital display, and more particularly to integrating head tracking in an imaging microscopy system, e.g., for (simulated) 3D (three dimensional) display.

### DESCRIPTION OF THE RELATED ART

Three dimensional (3D) displays (actually, simulated 3D, e.g., via stereo display (SD) techniques) are increasingly utilized for a variety of applications, including, for example, remote viewing, videoconferencing, video collaboration, and so forth. Such systems use techniques that may be referred to in any of a variety of ways, e.g., “3D imaging”, “3D display”, “stereo imaging”, and so forth, and may utilize special stereo display devices such as polarized liquid crystal (LCD) displays, shutter glasses, dual color (e.g., red/blue) glasses, etc.

Moreover, imaging microscopy is increasingly used in a wide variety of applications, and broadly covers a wide variety of microscopic imaging technologies besides optical light based imaging. Imaging microscopy includes, but is not limited to, electron microscopy, in which an electron beam is used in lieu of light to form the image, fluorescence microscopy, in which fluorescent materials emit visible light when irradiated with ultraviolet (UV) rays, immune electron microscopy, which refers to electron microscopy of biological specimens to which a specific antibody has been bound, immunofluorescence microscopy, which utilizes antibodies labeled with a fluorescing substance and a fluorescence microscope to detect the binding of the antibody via emission of a characteristic visible light under UV light, Nomarski microscopy, which utilizes a special optical system (referred to as “Nomarski optics”) to perform “differential interference contrast microscopy”, and time-lapse microscopy, in which the same object is imaged at regular intervals over time to characterize dynamic processes and systems, e.g., to observe a cell's division process, e.g., mitosis, meiosis, or binary fission, and so forth. Stereo microscopy combines microscopy techniques with 3D imaging techniques to image microscopic specimens in 3D/stereo.

Prior art FIG. 1 illustrates an exemplary imaging microscopy system, according to the prior art. The exemplary imaging microscopy system shown utilizes an electron beam (e-beam) from an electron gun that passes through first and second condenser lenses, and an objective lens that uses deflection coils to direct the beam, e.g., for scanning a specimen mounted on a specimen stage, with backscatter electron detector, x-ray detector, and secondary electron detector, for detecting emissions or reflections from the illuminated specimen. As also shown, a vacuum pump maintains a suitable vacuum for the apparatus.

Further exemplary microscopy systems are described in U.S. Pat. Nos. 3,585,382, 7,067,808, 3986027, 7329867, 7151258, and 3629577, (among others), each of which is hereby incorporated by reference.

Several prior art approaches to stereo microscopy that incorporate 3D imaging are described in an Agilent Technologies paper titled “Stereomicroscopy: 3D Imaging and the Third Dimension Measurement” by Dining Xie. In some of the approaches discussed therein, which utilize a scanning electron microscope (SEM), a physical stage upon which an object to be imaged is moved or tilted from a first position or orientation to a second position or orientation, and a respective image of the object captured at each position or orientation to form a stereo image pair, which is then rendered for stereo viewing; however, in this paper, sufficient parallax for effective stereo-optical imaging was achieved by sample tilting, but not via sample positioning.

In one particular implemented system (the described Agilent 8500 FE-SEM) described therein, a quad-segmented micro-channel plate (MCP) detector was utilized to create 3D images without any sample lateral shifting or sample tilting. More specifically, the Agilent 8500 system locates the quad-segmented MCP detector above the specimen to detect secondary electrons, as indicated in prior art FIG. 2, where an incident beam (which passes through the MCP detector, as shown) illuminates or stimulates a specimen mounted on a stationary specimen stage, and respective responsive emissions are captured from each of the quad segments of the MCP detector, referred to as channels 1, 2, 3, and 4. Note that such use of multiple segments (e.g., sensors) means that sample/specimen tilting does not affect illumination orientation, and so additional work is not required to record images from the (tilted) sample. In some cases, a eucentric stage may be used which enables pure tilting without introducing any lateral translation.

A further approach used in some prior art systems is to shift an electron beam as it exits the beam column of the system to generate the desired parallax for stereo imaging of an illuminated or excited sample.

However, in all such prior art systems and techniques, control of the point of view (POV) of the image capture process, and thus, the region of the specimen to be (stereo) imaged, is limited to traditional configuration techniques, e.g., configuration files, textual commands, computer-keyboards, computer mice, and so forth, and thus, do not readily facilitate real-time user navigation of the 3D physical space of the specimen.

### SUMMARY

Embodiments of a system and method of use for an imaging microscopy system are presented, such as a stereo imaging microscopy system.

A control module may be coupled to an imaging microscopy system, wherein the imaging microscopy system is configured to capture an image of a specified region of a staged physical specimen based on a specified perspective by controlling the specimen's position and/or orientation relative to an image capture subsystem of the imaging microscopy system corresponding to the specified perspective. The control module may be further coupled to a 6 degree of freedom (DOF) tracking device.

The 6 DOF tracking device may detect position and/or orientation of a 6 DOF object with respect to a display device of the imaging microscopy system, where the position and/or orientation of the 6 DOF object corresponds to a perspective for image capture of the specimen. The 6 DOF tracking device may send information indicating the detected position and/or orientation of the 6 DOF object to the control module.

The control module may determine the specified perspective based on the information indicating the detected position and/or orientation, and may further determine the specified region of the physical specimen for image capture based on the specified perspective. The control module may then send information indicating the specified region and the specified perspective to the imaging microscopy system, thereby controlling capture of the image by the image capture subsystem of the imaging microscopy system based on the specified region and the specified perspective. The information indicating the specified region and the specified perspective may be useable by the imaging microscopy system to capture an image of the specimen.

The image may be displayed on the display device. By iterating the above technique, the user may navigate the specimen or space around the specimen in real time.

### BRIEF DESCRIPTION OF THE DRAWINGS

A better understanding of the present disclosure can be obtained when the following detailed description of the preferred embodiment is considered in conjunction with the following drawings, in which:

FIG. 1 illustrates an exemplary microscopy system, according to the prior art;

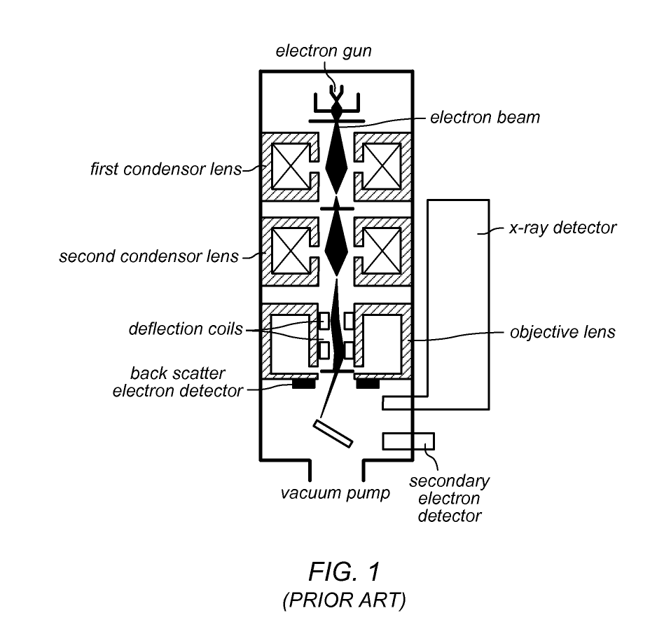

FIG. 2 illustrates a quad-segmented micro-channel plate (MCP) detector, according to the prior art;

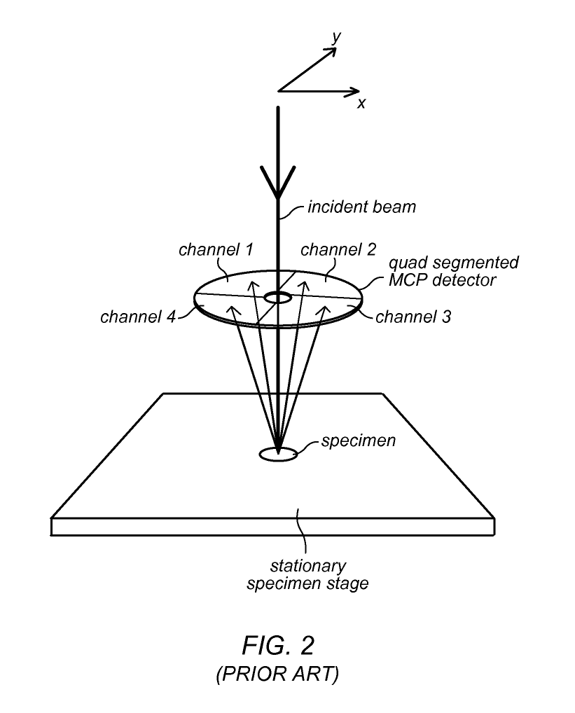

FIG. 3 illustrates various approaches to consecutive image stereo imaging, according to the prior art;

FIG. 4 is a high level block diagram of an exemplary imaging microscopy system coupled to an imaging microscopy control system, according to one embodiment;

FIG. 5 illustrates a more detailed embodiment of the exemplary imaging microscopy system coupled to an imaging microscopy control system of FIG. 4;

FIG. 6 is a flowchart diagram of a method for dynamically controlling an imaging microscopy system, according to one embodiment;

FIG. 7 illustrates a more detailed exemplary embodiment of the system of FIG. 5; and

FIG. 8 shows a relationship between magnification levels and interpupillary distance (IPD), according to one embodiment.

While the disclosure is susceptible to various modifications and alternative forms, specific embodiments thereof are shown by way of example in the drawings and are herein described in detail. It should be understood, however, that the drawings and detailed description thereto are not intended to limit the disclosure to the particular form disclosed, but on the contrary, the intention is to cover all modifications, equivalents and alternatives falling within the spirit and scope of the present disclosure as defined by the appended claims.

### DETAILED DESCRIPTION

### Incorporation by Reference

The following references are hereby incorporated by reference in their entirety as though fully and completely set forth herein:
U.S. Provisional Application Ser. No. 61/622,811, titled “Integrate Head Track To Optical Inspection System”, filed Apr. 11, 2012.
U.S. patent application Ser. No. 13/481,243, titled “Optimizing Stereo Video Display”, filed on May 25, 2012.
U.S. application Ser. No. 13/182,305, titled “Tools for Use within a Three Dimensional Scene”, filed Jul. 13, 2011.
U.S. application Ser. No. 13/300,424, titled “Tightly Coupled Interactive Stereo Display”, filed Nov. 18, 2011.
U.S. Application Ser. No. 61/561,687, titled “Head Tracking using eyewear with 5 reflector points”, filed Nov. 18, 2011.
U.S. patent application Ser. No. 13/333,339, titled “Three-Dimensional Collaboration”, filed on Dec. 21, 2011.
U.S. patent application Ser. No. 13/333,299, titled “Three-Dimensional Tracking of a User Control Device in a Volume”, filed on Dec. 21, 2011.
U.S. Provisional Application Ser. No. 61/491,052, titled “Three Dimensional Presentation Development System”, filed May 27, 2011.
U.S. patent application Ser. No. 13/019,384, titled “Modifying Perspective of Stereoscopic Images Based on Changes in User Viewpoint”, filed on Feb. 2, 2011.
U.S. patent application Ser. No. 11/098,681 (U.S. Patent Publication No. 2005/0219694), titled “Horizontal Perspective Display”, filed on Apr. 4, 2005.
U.S. patent application Ser. No. 11/141,649 (U.S. Patent Publication No. 2005/0264858), titled “Multi-plane Horizontal Perspective Display”, filed on May 31, 2005.
U.S. patent application Ser. No. 17/797,958, titled “Presenting a View within a Three Dimensional Scene”, filed on Jun. 10, 2010.
U.S. patent application Ser. No. 13/110,562, titled “Liquid Crystal Variable Drive Voltage”, filed on May 18, 2011.

### TERMS

The following is a glossary of terms used in the present application:

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Memory Medium—any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, EEPROM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), smart phone, television system, grid computing system, or other device or combinations of devices. In general, the term “computer system” can be broadly defined to encompass any device (or combination of devices) having at least one processor that executes instructions from a memory medium.

Comprising—this term is open-ended. As used in the appended claims, this term does not foreclose additional structure or steps. Consider a claim that recites: “A system comprising a display . . . .” Such a claim does not foreclose the apparatus from including additional components (e.g., a voltage source, a light source, etc.).

Configured To—various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

First, Second, etc.—these terms are used as labels for nouns that they precede, and do not imply any type of ordering (e.g., spatial, temporal, logical, etc.). For example, in a system having multiple tracking sensors (e.g., cameras), the terms “first” and “second” sensors may be used to refer to any two sensors. In other words, the “first” and “second” sensors are not limited to logical sensors 0 and 1.

Based On—this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

Interpupillary distance (IPO)—the distance between the centers of the pupils of a user's two eyes.

Perspective—a point of view (POV) of a person or handheld 6 DOF controller with respect to a display screen that presents an object (or scene) to be viewed, which may be used to specify a corresponding POV for an imaging system or subsystem with respect to the object to capture images of the object for viewing.

Projection—how an object of interest (e.g., a specimen) is captured by an imaging system or subsystem, i.e., the geometric alignment or relationship of an image capture (sub)system with respect to the object to capture images of the specimen in a manner that reflects a specified perspective, e.g., of a user or handheld 6 DOF controller.

### Overview

Below are described various embodiments of a system and method for dynamically controlling an imaging microscopy system, e.g., for visually navigating in a microscopic 3D space (or simply 3-space or space) by controlling an imaging point of view (POV) via a head tracking system and/or a 6 degree of freedom (DOF) handheld controller, e.g., a 3D stylus. Note that a typical computer mouse does not have 6 DOF, and so the hand held controller is specifically not a standard computer mouse. Exemplary embodiments of such 3D POV control devices and techniques are described in U.S. application Ser. No. 13/182,305, titled “Tools for Use within a Three Dimensional Scene”, filed Jul. 13, 2011, which was incorporated by reference above.

More specifically, various systems and techniques are described herein that integrate real-time user control of imaging perspective with imaging microscopy, thereby facilitating user navigation of microscopy imagery. In some embodiments, the imaging may be in stereo, and thus, the techniques disclosed herein may facilitate such navigation of microscopy imagery in 3-space, i.e., “stereo microscopy”. The 6 DOF control devices and techniques disclosed may be used to control any of various mechanisms to accomplish the navigation, e.g., a head tracking system and/or a handheld 3D stylus may be used to navigate a displayed 3D (stereo) image with one or more degrees of freedom (DOF), e.g., 6 DOF, by controlling a motorized stage, optics (e.g., beam geometries, lenses, detectors, etc.), or any combination of the two (where “optics” is meant in a broader sense than just light-based systems, i.e., to cover systems employing broad spectrum or coherent light, electron beams, ion beams, and so forth). Thus, techniques for navigating in 3D graphics space, as per U.S. application Ser. No. 13/182,305 are extended and applied to navigation in 3D physical space. Note that the techniques disclosed herein are broadly applicable to any of various types of microscopy systems and approaches, e.g., scanning electron microscopy (SEM), transmission electron microscopy (TEM), focused ion beam microscopy (FIB), atomic force microscopy (AFM), optical microscopy, and so forth, as desired.

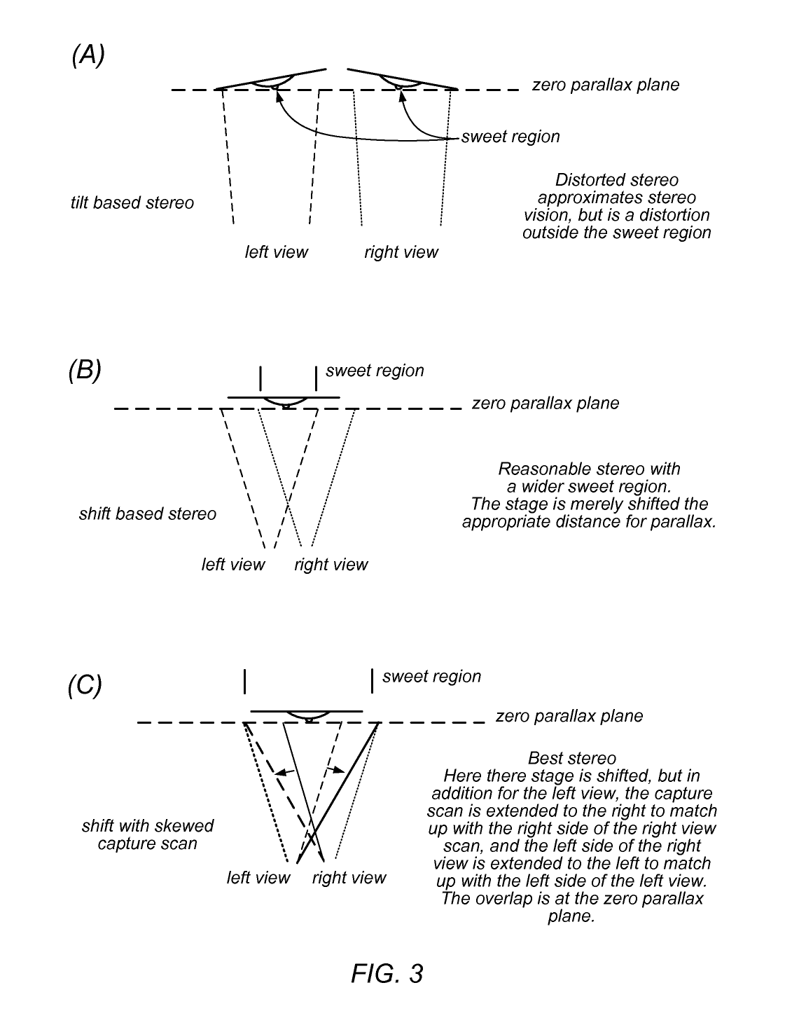

FIG. 3 illustrates focal plane related issues for various approaches for generating stereoscopic (e.g., 3D) images via successive image capture, according to one embodiment. As noted above, current (prior art) techniques for generating stereo imagery in an imaging microscopy system include platen (specimen stage) tilt, platen shift, and sensor offsets.

In the platen tilt approach, the platen or specimen stage is tilted one way, then another, to capture a stereo pair of images. The tilt amount may be based on the magnification factor (level) specified. As may be seen in the top portion of the Figure, labeled “(A)”, the left and right views (for imaging a specimen) used to create a stereo visual effect regard the specimen from respective angles or perspectives via different tilt positions of the specimen stage. However, as this figure also shows, there is a “sweet region” (or sweet spot) defined by the specimen's position/orientation and the plane at which there is no parallax between the two views, referred to as the zero parallax plane. In other words, the “sweet region” is where the specimen (or specimen portion) is in focus in both views. Thus, for example, per the Figure, the left end of the specimen is at a different distance in the two views, as is the right end, neither of which is in the sweet region, and thus these portions cannot be in focus in both views. Note that in some embodiments, the two views may be respectively captured with respect to an initial or default tilt value, then a second tilt value. Alternatively, the platen may start out in an initial, e.g., neutral, position, then may be tilted in one direction for the first image capture, then tilted in another (e.g., the opposite) direction for the second image capture.

Note that this approach produces a distorted stereo effect that approximates stereo vision in the sweet region, but introduces distortion outside this region.

In the platen shift approach, the first view is with the platen in a first, initial, or default, position, then another, to capture the stereo pair of images, where the shift amount is based on the magnification factor specified. The middle portion of FIG. 3, labeled “(B)” illustrates this technique where, as indicated, the portion of the specimen to be (stereo) imaged is shifted (by shifting the specimen stage) while remaining in the zero parallax plane. Note, however, that due to the lateral shift between views, the specific area or region of image capture may be adjusted such that the specimen (or specimen portion) is in (at least roughly) the same position in the two images. In some embodiments, the first image may be captured with the platen in a default position, and the shift once to capture the second image, the platen may start in an initial or default position, and may be moved one way to capture the first image, then another to capture the second. Alternatively, in some embodiments, the platen may move from the initial or default position to a first position for capture of the first image, and to a second position (e.g., on the other side of the default position) for capture of the second image.

Note further that in an alternate version of this technique, the stage may be stationary while other elements of the imaging system are shifted, which can produce the same stereo effect. Thus, the important point is that the specimen and the imaging apparatus have a relative lateral shift between the respective image captures of the two images of the stereo image pair.

This approach provides reasonable stereo vision effects with a wider sweet region than the tilting approach shown in (A). Note that by shifting the stage, the image capture of a light capture microscope (e.g. a laser scan microscope), the area of view of the distinct left and right stereo imagery can be captured with an adjustment of the area of view, thereby allowing for zero parallax and consistent focus with complete left/right overlap regions. In this case, the “sweet region” is the area of capture (in the zero parallax plane) where the region of the object to be imaged is in both the left and right images/views.

Thus, in some embodiments, the shift approach of (B) may be combined with a modified capture (e.g. raster scan or other capture) to improve the resultant stereo effect, as illustrated in the bottom of FIG. 3 and labeled “(C)”. In other words, when shifting the stage as the means to capture the left-right views, the capture of the (e.g., light capture) microscope maybe corrected or adjusted to define the area of view for each of the distinct left and right stereo pair imagery. As shown, in this exemplary embodiment, the stage is shifted, but in addition, for the left view the capture is extended to the right (see right-pointing arrow) to match up with the right side of the right view capture, and the left side of the right view capture is extended to the left to match up with the left side of the left view capture. Note that the overlap is in the zero parallax plane, and defines the sweet region. This technique may produce the best stereo effect of the techniques illustrated in FIG. 3.

In the sensor offsets approach, a sensor may be biased in one way, then another, such that the sensor detects electrons (or other imaging signals) from slightly offset sections of the specimen to generate the stereo image pair, e.g., via use of a quad-segmented sensor, per the Agilent Technologies microscopy system discussed above. This offset approach may be combined with any of the above approaches to generate even stronger stereo effect.

In some embodiments, existing scan coils of the imaging microscopy system being controlled may be used to shift the center of the electron beam capture to create the two views for stereo image capture. This technique has not been used in prior art systems for stereo image pair generation. Of course, any of the above techniques may be used in any combinations desired.

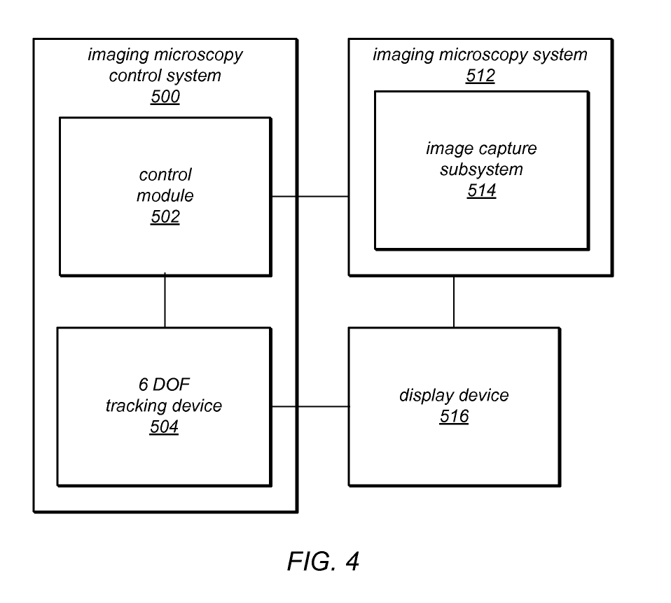

### FIG. 4—Block Diagram of Exemplary System

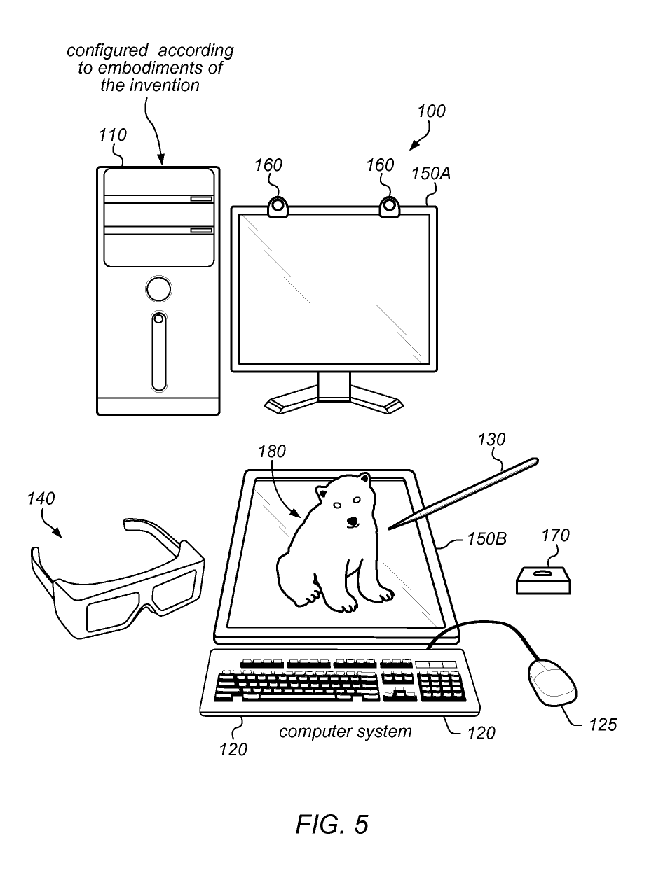

FIG. 4 is a high level block diagram of an exemplary system for controlling an imaging microscopy system (shown coupled to the imaging microscopy system), according to one embodiment. As shown, in the simplified embodiment of FIG. 5, an imaging microscopy control system 500 includes a control module 502 that may be coupled to an imaging microscopy system 512, which may include an image capture subsystem 514, functionality of which is discussed below. The imaging microscopy control system 500 may further include a 6 degree of freedom (DOF) tracking device (or system), coupled to the control module 502, and further coupled to a display device 516, which may also be coupled to the imaging microscopy system 512, as shown. As described below in detail, the 6 DOF tracking device may be configured to detect position and/or orientation of a 6 DOF object, such as a user's head or other body part, or 6 DOF hand-held controller, such as a 3D stylus, with respect to the display device 516, and send information indicating the detected position and/or orientation to the control module 502, which may be configured to control the image capture subsystem 514 of the imaging microscopy system 512 to capture stereo pairs of images of a microscopic specimen, thereby facilitating real time user navigation of the specimen.

### FIG. 5—Detailed Exemplary System

FIG. 5 illustrates a more detailed exemplary system 100 configured to implement various embodiments described herein. In the embodiment of FIG. 5, the system includes a computer system 110 (possibly including a chassis), display 150A and display 150B (which may collectively be referred to as display 150 or “at least one display” 150), keyboard 120, mouse 125, stylus 130 (or other 6 DOF hand held controller), eyewear (e.g., stereo glasses) 140, one or more cameras 160, and stylus caddy 170. In one embodiment, at least one of the displays 150A and 150B is a stereoscopic display. For example, in one embodiment, both of the displays 150A and 150B are stereoscopic displays.

The computer 110 may include various computer components such as processors, memory mediums (e.g., RAM, ROM, hard drives, etc.), graphics circuitry, audio circuitry, and other circuitry for performing computer tasks, such as those described herein. The at least one memory medium may store one or more computer programs or software components according to various embodiments of the present disclosure. For example, the memory medium may store one or more graphics engines which are executable to render stereo images, according to embodiments of the methods described herein. The memory medium may also store data (e.g., a computer model) representing a virtual/graphic space, which may be used for projecting a 3D scene of the virtual space via the display(s) 150. The virtual/graphic space may itself map to a physical “microscopy space”, which is used herein to refer to the actual physical space of and surrounding a specimen mounted on a specimen stage of an imaging microscopy system. Note that this physical space is distinct from, but may map to, the world space that the user occupies, e.g., within which the user may specify a view perspective, e.g., via a head (or other body part) tracking device or hand-held 6 DOF controller, such as the 3D stylus 130.

Further, the memory medium may store (tracking) software which is executable to perform 3D spatial tracking of stylus 130 (or other hand-held 6 DOF controller) or of a user's (6 DOF) body part, e.g., head, eyes, hand, finger(s), etc., as desired, which may be used as a 6 DOF object or controller to specify and control image capture of a specimen by an imaging microscopy system. In some embodiments, the software may be further executable to render a representation of the 6 DOF controller or 6 DOF body part as part of the stereo image pair (or even a mono image), e.g., in the form of a 3D cursor or (possibly 6 DOF) perspective indicator.

Additionally, the memory medium may store operating system software, as well as other software for operation of the computer system. Various embodiments further include receiving or storing instructions and/or data implemented in accordance with the foregoing description upon a carrier medium. As indicated above, the computer system 100 may be configured to display a three dimensional (3D) scene (e.g., via stereoscopic images) using the display 150A and/or the display 150B.

It should be noted that the embodiment of FIG. 5 is exemplary only, and other numbers of displays are envisioned. For example, the computer system 100 may include only a single display or more than two displays, or the displays may be arranged in different manners than shown. In this particular embodiment, the display 150A is configured as a vertical display (which is perpendicular to a user's line of sight) and the display 150B is configured as a horizontal display (which is parallel or oblique to a user's line of sight). The vertical display 150A may be used (e.g., via instructions sent by a graphics engine executing in the computer 110) to provide images which are presented according to a vertical (or central) perspective and the display 150B may be used (e.g., via instructions sent by a graphics engine executing in the computer 110) to provide images which are presented according to a horizontal perspective. Descriptions of horizontal and vertical perspectives are provided herein. Additionally, while the displays 150 are shown as flat panel displays, they may be any type of system which is capable of displaying images, e.g., projection systems. Note that the tilt angle of the display(s) may be different from vertical and horizontal positions. For example, various degree offsets from vertical are contemplated (e.g., 15, 30, 45, 60, and 75 degrees). In one embodiment, a single display may be used that has a 30 degree tilt angle.

Either or both of the displays 150A and 150B may present (display) stereoscopic images for viewing by the user. By presenting stereoscopic images, the display(s) 150 may present a 3D scene for the user. This 3D scene may be referred to as an illusion since the actual provided images are 2D, but the scene is conveyed in 3D via the user's interpretation of the provided images. In order to properly view the stereoscopic images (one for each eye), the user may wear eyewear 140. Eyewear 140 may be anaglyph glasses, polarized glasses, shuttering glasses, lenticular glasses, etc. Using anaglyph glasses, images for a first eye are presented according to a first color (and the corresponding lens has a corresponding color filter) and images for a second eye are projected according to a second color (and the corresponding lens has a corresponding color filter). With polarized glasses, images are presented for each eye using orthogonal polarizations, and each lens has the corresponding orthogonal polarization for receiving the corresponding image. With shutter glasses, each lens is synchronized to alternations of left and right eye images provided by the display(s) 150. The display may provide both polarizations simultaneously or in an alternating manner (e.g., sequentially), as desired. Thus, the left eye is allowed to only see left eye images during the left eye image display time and the right eye is allowed to only see right eye images during the right eye image display time. With lenticular glasses, images form on cylindrical lens elements or a two dimensional array of lens elements. The stereoscopic image may be provided via optical methods, where left and right eye images are provided only to the corresponding eyes using optical means such as prisms, mirror, lens, and the like. Large convex or concave lenses can also be used to receive two separately projected images to the user.

In one embodiment, the eyewear 140 may be used as a position input device to track the eyepoint of a user viewing a 3D scene presented by the system 100, i.e., as the 6 DOF tracking device. For example, eyewear 140 may provide information that is usable to determine the position of the eyepoint(s) of the user, e.g., via triangulation. The 6 DOF tracking device may include an infrared detection system to detect the position the viewer's head to allow the viewer freedom of head movement or use a light sensitive detection system. Other embodiments of the 6 DOF tracking device can utilize a triangulation method of detecting the viewer eyepoint location, such as using at least two tracking sensors (e.g., at least two CCD cameras) to provide position data suitable for the 6 DOF tracking functionality disclosed. Further embodiments may utilize face recognition, feature detection and extraction, and/or target tracking algorithms based on optical images captured from the sensors. However, it should be noted that in various embodiments, any method for tracking the position of the user's head or other body part(s), e.g., eyepoint(s), or 6 DOF controller/object may be used as desired. Accordingly, the 3D scene may be rendered such that user can view the 3D scene with minimal distortions (e.g., since it is based on the eyepoint of the user). Thus, for example, the 3D scene may be particularly rendered for the (specified) eyepoint of the user, using the 6 DOF tracking device. In some embodiments, each eyepoint may be determined separately, or a single eyepoint may be determined and an offset may be used to determine the other eyepoint, e.g., a specified or measured IPD.

The relationship among the position/orientation of the display(s) 150 and the eye(s) (or head or stylus, etc.) position of the user may be used to map a portion of the physical (microscopy) space of the system or a corresponding virtual/graphic space to the world space of the user (from which the user may control the system), therefore the 6 DOF tracking device may be directly coupled to the display and the control system may have a direct position/orientation correlation offset between the tracking device and the coupled display device. Examples for implementing such a system are described in the incorporated-by-reference U.S. patent application Ser. No. 11/098,681 entitled “Horizontal Perspective Display” (U.S. Patent Publication No. US 2005/0219694), which was incorporated by reference in its entirety above.

In some embodiments, system 100 may be configured to capture images from at least two unique perspectives, for example, by one or more tracking sensors 160. Illustrated in FIG. 5 is an embodiment using two cameras 160. Cameras 160 may be used to image a user of system 100 (e.g., to capture stereoscopic images of the user), track a user's movement, or track a user's head or eyes. In one embodiment, cameras 160 may track a position and an orientation of stylus 130. The information regarding the position and/or orientation of the stylus 130 provided by the two or more cameras 160 may be used in conjunction with other additional information of the system (e.g., an accelerometer and/or gyroscope within the stylus itself) to perform more precise three dimensional tracking of the stylus 130. Cameras 160 may be spatially separated from one another and placed in a position to view a volume that encompasses where a user will view stereo imagery. Such a position may be in an embodiment in which cameras 160 are embedded in a housing of one of the displays 150 (e.g., display 150A). For instance, each camera may be positioned relative to a predefined position and orientation of one or more of displays 150 (e.g., as shown in FIG. 5, each camera may be embedded in display 150B at a predefined position and orientation). Cameras 160 may also be far enough apart from each other to provide for a separation of view for a true three-axis triangulation determination. System 100 may also include a caddy 170 to store or hold stylus 130. Caddy 170 may also be used to calibrate the orientation of the stylus to a known roll, pitch, and yaw. In one embodiment, caddy 170 may be in a fixed position relative to cameras 160.

In various embodiments, tracking sensor(s) 160 may sense a subject (e.g., a physical object, user, etc.). For example, a single tracking sensor may include a single sensor with multiple light fiber bundles with one bundle per view image (perspective) such that multiple images of the subject may be captured with each image having a different, or unique, perspective of the subject. As another example, a single sensor may capture multiple different perspectives by capturing the subject at slightly different times. Still in other examples, more than one tracking sensor may be used to capture the multiple different perspectives of the subject.

The 3D scene generator stored and executed in the computer 110 may be configured to dynamically change the displayed images provided by the display(s) 150. More particularly, the 3D scene generator may update the displayed 3D scene based on changes in the user's eyepoint, manipulations via the user input devices, etc. Such changes may be performed dynamically, at run-time. The 3D scene generator may also keep track of peripheral devices (e.g., the stylus 130 or eyewear 140) to ensure synchronization between the peripheral device and the displayed image. The system can further include a calibration unit to ensure the proper mapping of the peripheral device to the display images and proper mapping between the projected images and the virtual images stored in the memory of the computer 110.

Thus, the system 100 may present a 3D scene which the user can control in real time. The system may comprise real time electronic display(s) 150 that can present or convey perspective images in the open space, and a peripheral device 130 (or other 6 DOF tracking system) that may allow the user to navigate the 3D scene (e.g., of the specimen) in real time. The system 100 may also allow the displayed image to be magnified, zoomed, rotated, and moved. Or, system 100 may even display a new image.

Further, while the system 100 is shown as including horizontal display 150B since it simulates the user's visual experience with the horizontal ground, any viewing surface could offer similar 3D illusion experience. For example, the 3D scene can appear to be hanging from a ceiling by projecting the horizontal perspective images onto a ceiling surface, or appear to be floating from a wall by projecting horizontal perspective images onto a vertical wall surface. Moreover, any variation in display orientation and perspective (or any other configuration of the system 100) are contemplated.

In some embodiments, the memory medium may store firmware implementing at least a portion of the techniques described herein. Various embodiments further include receiving or storing instructions and/or data implemented in accordance with the foregoing description upon a carrier medium.

It should be noted that in various other embodiments, the system may be implemented with a workstation, or dedicated hardware (e.g., as opposed to a standard personal computer (PC) or workstation), such as a computing device configured with an ASIC (application specific integrated circuit) or programmable hardware element, e.g., a field programmable gate array (FPGA), among others. In one embodiment, all the control electronics may be embedded within the display itself, without need of an external computer. Moreover, as explained below, in further embodiments, any of various display techniques and devices may be used as desired, including, for example, stereoscopic display techniques and devices. Similarly, any types of memory may be used as desired, including volatile memory mediums such as RAM, or non-volatile memory mediums, e.g., EEPROMs, e.g., configured with firmware, etc., as desired.

Thus, in an exemplary embodiment, an imaging microscopy control system may be provided that include a control module, coupled to an imaging microscopy system. The imaging microscopy system may be configured to capture an image of a specified region of a specimen staged physical specimen based on a specified perspective by controlling the specimen's position and/or orientation relative to an image capture subsystem of the imaging microscopy system corresponding to the specified perspective. In other words, the imaging microscopy system may be operable to generate an image of a specimen based on a specified perspective, and may accomplish this by controlling the relative geometry of the (staged) specimen and the image capture subsystem of the imaging microscopy system. Note that the relative geometry (i.e., the specimen's position and/or orientation relative to the image capture subsystem), may involve the physical or spatial relationship between the specimen and any aspects of the image capture subsystem, including, for example, sensor positions, sensor channels (see quad-segmented sensor described above), incident beam geometries, and so forth, as desired

The imaging microscopy control system may also include a 6 degree of freedom (DOF) tracking device, coupled to the control module, and configured to detect position and/or orientation of a 6 DOF object with respect to a display device of the imaging microscopy system, where the position and/or orientation of the 6 DOF object corresponds to a perspective for image capture of the specimen, and send information indicating the detected position and/or orientation of the 6 DOF object to the control module. The control module may be configured to determine the specified perspective based on the information indicating the detected position and/or orientation, determine the specified region of the physical specimen for image capture based on the specified perspective, and send information indicating the specified region and the specified perspective to the imaging microscopy system, thereby controlling capture of the image by the image capture subsystem of the imaging microscopy system based on the specified region and the specified perspective.

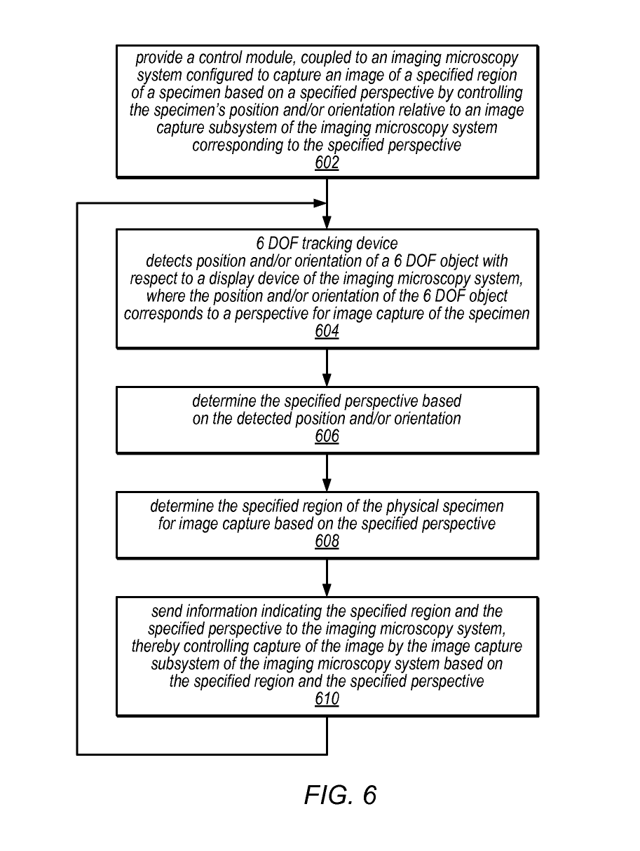

Further details regarding the imaging microscopy control system are presented below with reference to the method of FIG. 6.

### FIG. 6—Method for Controlling an Imaging Microscopy System

FIG. 6 is a flowchart diagram of a method for dynamically controlling an imaging microscopy system, according to one embodiment. The method shown in FIG. 6 may be used in conjunction with any of the computer systems or devices shown in the figures, among other devices. In various embodiments, some of the method elements shown may be performed concurrently, in a different order than shown, or may be omitted. In some embodiments, the method may include additional (or fewer) method elements than shown. As shown, the method may operate as follows.

In 602, a control module may be provided. As noted above, the control module may be coupled to an imaging microscopy system, where the imaging microscopy system is configured to capture an image of a specified region of a specimen staged physical specimen based on a specified perspective by controlling the specimen's position and/or orientation relative to an image capture subsystem of the imaging microscopy system corresponding to the specified perspective. As indicated above with reference to FIG. 5, the control module may be coupled to a 6 degree of freedom (DOF) tracking device.

In 604, position and/or orientation of a 6 DOF object with respect to a display device of the imaging microscopy system may be detected, e.g., via the 6 DOF tracking device, where the position and/or orientation of the 6 DOF object corresponds to a perspective for image capture of the specimen. Said another way, the 6 DOF tracking device (or system) may determine the position and/or orientation of a 6 DOF object relative to the display device of the imaging microscopy system.

In various embodiments, the 6 DOF tracking device may be any type of 6 DOF tracking device (or system) desired. For example, in some embodiments, the 6 DOF tracking device is or includes a head tracking device. In one embodiment, the head tracking device may be head mounted, such as a set of tracking glasses, a tracking cap, etc. In another embodiment, the head tracking device may include one or more sensors placed such that they can detect the user's head position and/or orientation, e.g., the one or more sensors, e.g., cameras, may be mounted on the display device. For example, the position and/or orientation of the 6 DOF object may be determined using camera triangulation, where, e.g., corresponding features of respective images of the user's head, face, eyes, etc., from the cameras may be compared and used to determine the position and/or orientation via triangulation. In a further embodiment, such sensors may operate in conjunction with other elements to perform the detection, e.g., reflective tags or other identifiable elements attached to the user's head or headgear (e.g., glasses). In another embodiment, the 6 DOF tracking device may be or include a hand held direct interaction device, e.g., a 6 DOF stylus (which could be of any form factor desired).

Similarly, in various embodiments, the 6 DOF object may be any of a wide variety of objects. For example, the 6 DOF object may include one or more of: a user's head, the user's eyes, one or more of the user's hands, one or more of the user's fingers, or a hand-held stylus, among others. In some embodiments, the 6 DOF tracking device and the 6 DOF object may be the same device. The position and/or orientation of the 6 DOF object (with respect to the display device) may indicate a desired perspective from which the specimen is to be imaged. The 6 DOF tracking device (or system) may send information indicating the detected position and/or orientation of the 6 DOF object to the control module.

In 606, the specified perspective may be determined, e.g., by the control module, based on the information indicating the detected position and/or orientation. In some embodiments, the control module may transform the detected position and/or orientation of the 6 DOF object to the specified perspective for imaging the specimen, e.g., mapping the position and/or orientation to a corresponding perspective in the context of “microscope space”, i.e., the space within which the specimen resides.

In 608, the specified region of the physical specimen for image capture may be determined, e.g., by the control module, based (at least) on the specified perspective. Said another way, in one embodiment, the control module may determine the region of the specimen to be imaged based on the determined specified perspective of 606, and in some embodiments, one or more additional parameters or attributes, e.g., magnification level.

In 610, information indicating the specified region and the specified perspective may be sent, e.g., by the control module, to the imaging microscopy system, thereby controlling capture of the image by the image capture subsystem of the imaging microscopy system based on the specified region and the specified perspective. In other words, the image capture subsystem of the imaging microscopy system is configured to capture an image of the specimen in response to the received (from the control module) information indicating the specified region and the specified perspective, and so the control module may thereby control image capture by the image capture subsystem by providing this information as input to the imaging microscopy system. The captured image may be displayed on the display device.

As FIG. 6 also shows, in some embodiments, after 610, the method may return to 604, and repeat the above method elements one or more times in an iterative manner, thereby facilitating (or implementing) real time navigation of the specimen (or microscope space) by the user. For example, the 6 DOF tracking device may be further configured to detect at least one subsequent position and/or orientation of the 6 DOF object with respect to the stereo display device of the imaging microscopy system. The at least one subsequent position and/or orientation of the 6 DOF object may correspond to at least one subsequent perspective for image capture of the specimen, as specified by a subsequent head position or position of another tracked object for either mono or stereo capture of the specimen image(s). The 6 DOF tracking device may send information indicating the detected at least one subsequent position and/or orientation of the 6 DOF object to the control module. Note that the successive specified perspectives, i.e., “control perspectives”, that determine image capture (e.g., as per the user's head position/orientation) should not be confused with the left/right perspectives corresponding to a user's left and right eyes that relate to the stereo pair of images; the left/right perspectives or views are applied for a given “control perspective”. Thus, for example, in a mono imaging system, image capture is specified by the (control) perspective, but there are no left/right views or perspectives.

The control module may be further configured to: determine at least one subsequent specified perspective based on the information indicating the detected at least one subsequent position and/or orientation, and determine at least one subsequent specified region of the physical specimen for stereo image capture based on the at least one subsequent specified perspective. The control module may send information indicating the at least one subsequent specified region and the at least one subsequent specified perspective to the imaging microscopy system, thereby controlling capture of at least one subsequent stereo image by the image capture subsystem of the imaging microscopy system based on the at least one subsequent specified region and the at least one subsequent specified perspective, thereby implementing real time navigation with respect to the specimen. In other words, by iteratively detecting a sequence of positions and/or orientations and controlling respective image captures of the specimen per this sequence, a user may navigate the space around the specimen and the specimen itself in real time intuitively via movements of the user's head, other user body part(s), and/or a hand-held direct interaction device, such as a 3D (6DOF) stylus, among others.

Note that such navigation is not limited to orthogonal views of the specimen; rather, the specified perspective may be a first oblique perspective and the at least one subsequent specified perspective may be a (or at least one) second oblique perspective. Similarly, the display device, with respect to which the position and/or orientation is detected, is not constrained to be positioned orthogonally with respect to the user, but may be an obliquely positioned display.

### Further Exemplary Embodiments

The following presents various further exemplary embodiments of the above method (and system), although it should be noted that the embodiments described are exemplary only, and are not intended to limit the invention to any particular form, function, or appearance.

As noted above, in some embodiments, the above approach may be used to capture stereo images for (simulated) 3D display of the specimen. More specifically, in some embodiments, the image of the specified region of the specimen staged physical specimen may include a stereo image, and the display device may be or include a stereo display device. Similarly, the image capture subsystem may be or include a stereo image capture subsystem. Controlling capture of the image may thus include controlling capture of the stereo image by the stereo image capture subsystem of the imaging microscopy system based on the specified region and the specified perspective. In one embodiment, the stereo display device may be included in the system (for controlling the imaging microscopy system), may be coupled to the imaging microscopy system, and may be configured to display the stereo image.

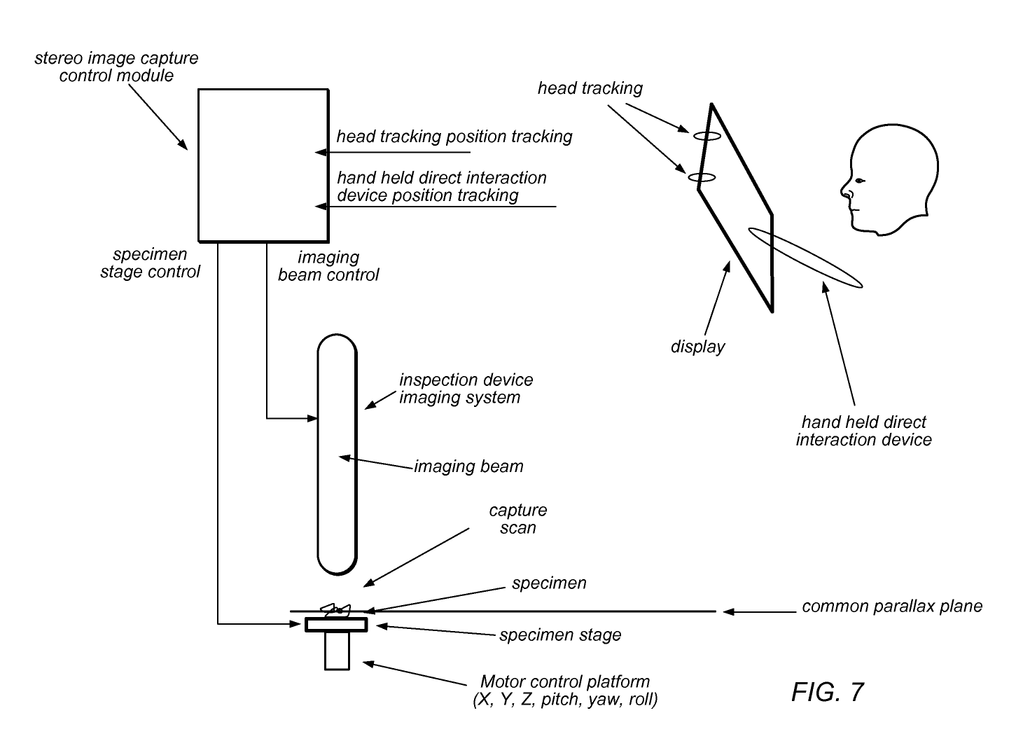

### FIG. 7—Detailed Exemplary System

FIG. 7 illustrates a more detailed exemplary embodiment of the system of FIG. 5, where a control system is coupled to an imaging microscopy system, referred to in this embodiment, as an inspection device imaging system.

As shown, in this particular exemplary embodiment, the control module is a stereo image capture control module, and two 6 DOF tracking devices (or systems) are used, including a head tracking device configured to track (or detect) the user's head position, as shown, and further including a hand held direct interaction device configured to track (or detect) the position of the hand held direct interaction device (e.g., 3D stylus). Of course, in some embodiments, either or both of these tracking devices may also track or detect orientation (in addition to position). As may be seen, the control system includes a display, upon which are mounted head tracking elements, e.g., two cameras, which, as noted above, may detect the user's head position by triangulation. Both of these tracking devices may send respective tracking information (regarding the user's head and the hand held direct interaction device) to the control module, as FIG. 7 shows. As an example, the display may have the tracking system attached to it, where the tracking system has a default coordinate system that coincides with the display, as an example, the display may be considered to be or define a plane, and the center of the display may be assigned a coordinate (X, Y, Z), where Z is 0. The specimen likewise may be imaged such that the capture is positioned at a default position of (A, B, C). The tracking system may initially be set to assume a user is at position (X, Y Z1), where Z1 is in negative space away from the display by distance Z1 and the user is looking at the display in a manner that the user is normal to the center of the display, with an orientation of pitch, yaw roll of (0,0,0) degrees. The image of the specimen may be correlated to this position/orientation. As the tracking system determines that the user has moved to a position (X1, Y1, Z2) with orientation (pitch1, yaw1 and roll1), the tracking system may convey this captured information and instruct the image capture control module to shift its relationship to the specimen (e.g., by one of the above described offset mechanisms), such that the image capture control module position/orientation with respect to the specimen (taking its zoom factor and any optics compensation related offset into account) is at a corresponding position/orientation of (X1, Y1, Z2) and with orientation (pitch1, yaw1 and roll1). The image capture control module may capture the images at this modified position/orientation of the specimen and presents these captured images onto the display.

As may also be seen, in this embodiment, the stereo image capture control module (or simply, the control module) may control the specimen stage, as indicated by the arrow coupling the control module to the specimen stage, labeled “specimen stage control”, via a motor control platform with adjustable positioning, specifically, X, Y, Z, pitch, yaw, and roll, parameters (although other DOFs may be used as desired, e.g., spherical coordinates, etc.) and may also control an imaging beam of the imaging microscopy system, as indicated by the arrow coupling the control module to the inspection device imaging system, which utilizes an imaging beam to perform a scan capture of the specimen on the specimen stage. As indicated, in this embodiment, the specimen may be held in a zero parallax plane, labeled “common parallax plane” in FIG. 7.

Thus, in the exemplary embodiment of FIG. 7, a user may control either or both of the specimen stage position and/or orientation, and the imaging beam (for capture scanning the specimen) via head tracking and/or hand-held direct interaction device, and thereby control the specified perspective from which the specimen is imaged.

In some embodiment, the detected position and/or orientation may include both position and orientation, e.g., all 6 DOFs of the 6 DOF object may be detected. Moreover, since 6 DOFs may be more than are needed to specify the desired perspective for imaging the specimen, in some embodiments, a first subset of the 6 DOFs of the 6 DOF tracking device may correspond to the detected position and/or orientation, and a second subset of the DOFs of the 6 DOF tracking device may correspond to one or more auxiliary control parameters for the image capture subsystem. For example, the one or more auxiliary control parameters may include one or more of: magnification level of the imaging microscopy system, focal plane of the imaging microscopy system, or one or more scanning parameters, among others.

Accordingly, the 6 DOF tracking device may be further configured to detect values of the second subset of the DOFs of the 6 DOF tracking device and send information indicating the detected values to the control module. The control module may thus be configured to determine the specified perspective based on the first subset of the 6 DOFs of the 6 DOF tracking device, determine the one or more auxiliary control parameters based on the detected values of the second subset of the DOFs, and determine the specified region based on the specified perspective and the one or more auxiliary control parameters corresponding to the second subset of the DOFs of the 6 DOF tracking device.

As one example of such auxiliary control, the distance from the user's head to the display device may be specified to correspond to magnification level for imaging the specimen, and so the user may lean towards the display device to “zoom in” on the specimen, and may lead away from the display device to “zoom out” from the specimen. Such functionality may provide a very natural user experience in stereo 3D, e.g., humans generally move their heads (eyes) closer to an object to view the object in greater detail, and vice versa. Note, however, that in other embodiments, any of the 6 DOFs may correspond to any auxiliary viewing or imaging parameters as desired.

As noted above, there are a variety of ways the imaging microscopy system can control the specimen's position and/or orientation relative to an image capture subsystem of the imaging microscopy system. In various embodiments, controlling the specimen's position and/or orientation relative to an image capture subsystem of the imaging microscopy system may include controlling one or more of: position and/or orientation of the specimen stage, position and/or orientation of one or more sensors of the image capture subsystem, incident beam geometry of the imaging microscopy system, or position and/or orientation of a microscope scan head of the imaging microscopy system with respect to the specimen stage, (where, for example, the specimen stage is stationary), among others.

In various embodiments, the imaging microscopy system may utilize one or more of multi-spectrum light, laser, electron beams, or ion beams to image the specimen. More generally, any type of imaging signals may be used as desired, e.g., sound waves, including ultrasound, sonar, phonons, etc.

As discussed above, in some embodiments, the imaging microscopy system may be a stereo imaging microscopy system. Accordingly, capture of the stereo image by the image capture subsystem of the imaging microscopy system may include capture of a stereo pair of images for display on the stereo display device. In one embodiment, the control module may be further configured to provide a specified interpupillary distance (IPD) that defines a spatial separation between two stereo views corresponding to the stereo pair of images for viewing by a user, thereby controlling capture of the stereo pair of images in accordance with the determined IPD. Thus, for example, a user may specify (or the system may detect) an IPD that optimizes stereo viewing by the user, and the system may control the imaging microscopy system to generate stereo image pairs accordingly for display to the user.

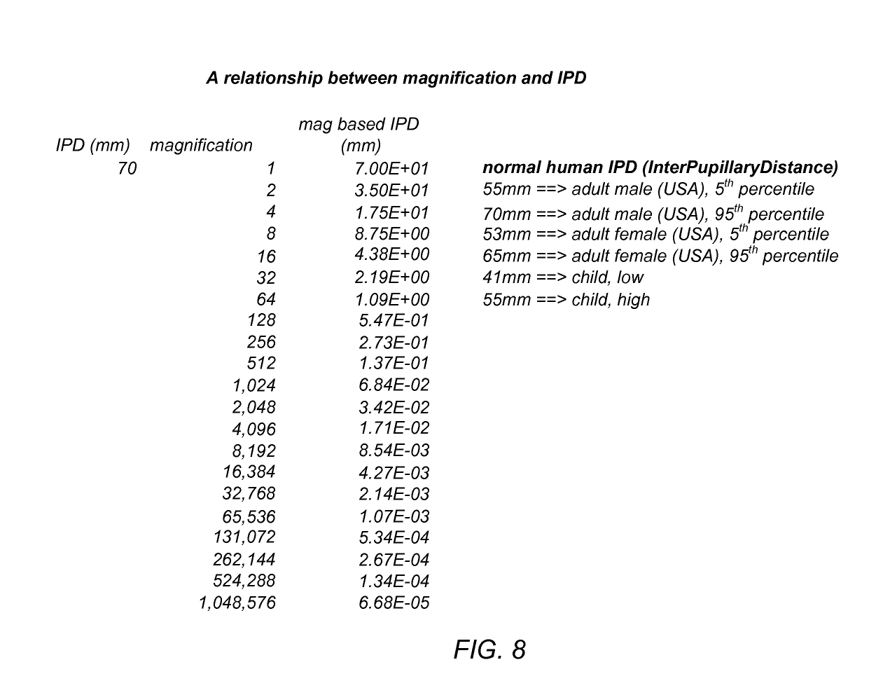

Moreover, in one embodiment, the control module is configured to adjust the apparent system capture IPD based on a specified magnification level of the image capture subsystem. In other words, the control module may adjust the corresponding left/right separation of the stereo image capture based on the specified magnification level to ensure the proper stereo image pair separation, thereby optimizing display of the stereo image to the user. FIG. 8 shows a relationship between magnification levels and interpupillary distance (IPD), according to one embodiment. As may be seen, the normal IPD for an adult male in the United States is approximately 70 mm, but decreases rapidly with increasing magnification levels, ranging from 70 mm at a magnification level of 1, to 6.68E-05 mm at a magnification level of 1,048,576. In one embodiment, the control module may be configured to control capture of the stereo pair of images such that the captured stereo pair of images share a common parallax plane (see, e.g., FIG. 3), e.g., the zero parallax plane. In some embodiments, the specimen stage of the imaging microscopy system may be or include a eucentric stage, which refers to a stage positioned and controlled such that the specimen (or a specified portion thereof) may be tilted without incurring lateral movement. In other words, the stage may position the specimen such that tilting the specimen to capture the images does not introduce lateral translation, where the position of the specimen (or specified portion thereof) coincides with the center of rotation about which the tilting occurs.

In some embodiments, the image capture subsystem may be configured to capture the stereo pair of images concurrently, e.g., with multiple sensors operating concurrently, e.g., dual sensors/cameras, etc. However, in other embodiments, the image capture subsystem may be configured to capture the stereo pair of images consecutively, as described above in detail, where, for example, a first image of the stereo pair of images is captured according to a first relative geometry (e.g., tilt angle, lateral shift, beam deflection, etc.), and a second image of the stereo pair of images is captured according to a second relative geometry.

For example, in a beam deflection embodiment, the imaging microscopy system may be configured to utilize an electron or ion beam to image the specimen, and deflect the electron or ion beam using scan coils to shift the center of the capture scan from a first position whereby a first image of the stereo pair of images is captured, to a second position whereby a second image of the stereo pair of images is captured. Thus, the stereo pair of images may be captured (from different views) without moving the specimen or the sensors. It should be noted, of course, that any of the above approaches to manipulating the relative geometry of the specimen and the image capture subsystem may be combined as desired to produce the stereo pair of images.

In one embodiment, the stereo display device may include a first display, configured to display the stereo image based on the specified perspective, and a second display, configured to display the stereo image according to another perspective that is different than the specified perspective. Thus, the user may view or track multiple stereo views of the specimen at the same time.

### Further Detailed Embodiments

The following presents further detailed contemplated embodiments and use cases. However, it should be noted that the embodiments described are meant to be exemplary only, and are intended solely to illustrate some of the techniques disclosed above.

In one exemplary embodiment, a head tracking system captures the change in perspective of the user being tracked. In 3D based systems, such as in a stereo display system, the change in head position correlates generally to the user's intent to see a slightly different view or perspective of the specimen being imaged. When the imaging system is a SEM, FIB, TEM, optical microscope, laser scan microscope, or AFM, the 3D information captured is generally only from one perspective (whether it be mono or stereo image capture), and that is from a default orientation of the image capture means with respect to the position of the specimen.

There are many ways for a head tracking system to integrate to a specimen imaging system. The following techniques (among others) are considered for a dual image stereo system, but may be applied to a mono imaging system as well.

A) specimen stage based control: The positional offset information from the head tracking system may control the stage upon which the specimen is resting. As the head is tracked to move in any of the X, Y, Z, pitch, yaw or roll coordinates (DOFs), the detection system may correlate the change to a corresponding control of the specimen stage in any of the X, Y, Z, pitch, yaw or roll coordinates. However, a scale factor may need to be introduced, e.g., based on the magnification of the imager. For a very high magnification the scale translation may be very large and for a low magnification setting, the scale translation may be smaller. For stereo pair capture, there may be an offset in the X coordinate (DOF) of the stage, meaning that for one eye view the stage is at the current X position with a negative offset, followed by a positive offset for the second eye view. Another technique to capture the stereo pair is through using a +/−tilting of the stage for the two eye views. The scaling of the magnification setting may determine the stereo pair spatial offset for left eye-right eye image pair capture. The lower the magnification the greater the physical image pair spatial capture offset.

B) detector based control: As per “Stereomicroscopy: 3D Imaging and the Third Dimension Measurement”, by Dining Xie of Agilent Technologies, there is a technique to use a micro-channel plate detector to set a first bias of the detector for one eye view and a second bias on the detector for a second eye view, thereby providing the stereo image pair on a SEM using the conventional raster scan of the beam. Depending upon the size of the detector and the control of the detector's bias, one may create a shift of the image pair that may correlate to the change in the head tracked current perspective.

C) illumination source based control: In a beam induced system (e.g., ion beam, electron beam, etc.) the raster scan of the beam to the specimen may have an offset induced by the deflection coils and/or of the condenser lens, where the capture scan may be centered from an offset of the center of the magnetic aperture for one eye view with an opposite offset from the center for the second eye view. The head tracking (e.g., X, Y, Z, pitch, yaw or roll) changes in position may control the beam offset for an X,Y change if within the aperture available range, but may be a combination control of the stage, sensor and/or beam for other coordinate changes.

Stylus: The handheld stylus or other user interface tool, may define the positioning and zoom of the to-be-displayed imagery, by having direct effect on the region of raster scan of the capture device (e.g., SEM) as well as the tilt and positioning of the stage. The handheld device as being tracked by the tracking system for its position and orientation as in the tracking process described above) may engage the imaging microscopy system, which in turn may capture the live image from the capture device or may interact with an aligned model or previously captured live image, which then drives the stage and optics to capture a new view that may be rendered to the interactive display when fully captured, which again may be used as an environment for further stylus based or head movement based navigation.

Movement: As the stage is in motion, the SEM image may not be able to perform the full rendering of the stereo pair in real time. To prevent the blurry image that would result in real time imaging, while the stage is in motion, the system will revert to mono imaging and show the same image for left and right views. Upon stage or scan steady state, either the system will revert to slowly evolving stereo as the stereo image pair builds or the system remains in a mono view, until the stereo image is at least at a reasonable level. The system may also revert to freezing in place the last captured image (or image pair) until the stage and/or subsequent imaging stabilizes, at which time the new live image may be captured and displayed on the display.

Appropriate Stereo: an optimal stereo effect may be achieved when the respective perspectives for the two views are shifted and not tilted. The system may identify the appropriate shift to most closely replicate natural stereo view seen by the viewer. An optimal stereo view may be of an object 2-15 feet from the front of the user where the IPD is approximately 2.8 inches, and where the features of the object are of approximately ¼ inch or greater. Determining the appropriate relationship among field of view, delta depth of object features, magnification and IPD that closely resembles human scale stereo view is somewhat deterministic. Human scale stereo may be based on an average IPD of about 2.8 inches, with objects from about 1.5 to 12 feet from the viewer. Within this “normal” range human stereo perception can recognize spatial depth within the objects of nearly ⅛ of an inch deep by ⅛ across or greater. Resolving spatial depth smaller than ⅛ deep and across may require closer-in viewing of the object. To stereo image and perceive human scaled depth relationship may require magnification as with a microscope, SEM, TEM, FIB, etc. To perform the appropriate effective IPD or separation of the left/right stereo image pair it may be important that the relationship among the parameters mentioned are maintained. As an example, the ratio of distance from the objective of the imager (e.g., objective lens or center of raster-scan from the SEM deflection coil) to the separation of the capture (either by stage movement or deflection of the center of the raster scan) remains within the human scale ration of about 15 feet divided by 2.8 inches. The ratio may be driven by the magnification setting of the imaging equipment. Changes to the ratio may occur for a change in human scale IPD (i.e., children have a smaller IPD than adults) or the size of the depth to be perceived in the stereo view or the exaggeration of the stereo depth to be viewed. As an example, for depth that is too small relative to distance and/or IPD, it may be advantageous to narrow the IPD for better stereo contrast. Independent of the scale and settings to obtain the stereo effect sought, it may be important to track the offsets from the normal stereo view, so any measurement that is to be taken or any motion to be implemented, the appropriate scaling relating to absolute distances are to be maintained.

Exemplary points of novelty of various of the above embodiments may include, but are not limited to:
within a stereo view of a magnification imaging system, use head tracking system to drive the change in perspective of the magnification imaging system, by adjusting the imaging capture (raster scan of a SEM type device) and/or adjusting the multi-degree of motion stage hosting the object to be imaged. The user may subsequently use the handheld device or a gesture to effect the change in position of the position/orientation view of the specimen independent of the head tracked perspective.
within a stereo view of a magnification imaging system, use freehand stylus and detection system to drive the change in perspective of the magnification imaging system, by adjusting the imaging capture (raster scan of a SEM type device) and/or adjusting the multi-degree of motion stage hosting the object to be imaged.
track and/or maintain the absolute spatial tracking of view objects dependent upon magnification, IPD, field of view of objects being viewed. This is done to support absolute movement of object stage or imaging system, based on direct interaction of a handheld user interface control mechanism and/or head tracking system.
using either a depth map or a recognized scaled spatial space determined by inspection system magnification setting, spatial display based on display zoom, DPI of the display and resolution of the stylus and/or head tracking system, determine spatial offset of change in stylus position or head position and the corresponding change to be made to the magnification imaging system and/or its stage.

Note that the above points of novelty or illustrative only, and are in no way an exhaustive list of the innovations disclosed herein.

It should be noted that the above-described embodiments are exemplary only, and are not intended to limit the invention to any particular form, function, or appearance. Moreover, in further embodiments, any of the above features may be used in any combinations desired. In other words, any features disclosed above with respect to one method or system may be incorporated or implemented in embodiments of any of the other methods or systems.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. An imaging microscopy control system comprising:
a control module, coupled to an imaging microscopy system, wherein the imaging microscopy system is configured to capture an image of a specified region of a specimen staged physical specimen based on a specified perspective by controlling the specimen's position and/or orientation relative to an image capture subsystem of the imaging microscopy system corresponding to the specified perspective;
a 6 degree of freedom (DOF) tracking device, coupled to the control module, and configured to:
detect position and/or orientation of a 6 DOF object with respect to a display device of the imaging microscopy system, wherein the position and/or orientation of the 6 DOF object corresponds to a perspective for image capture of the specimen; and
send information indicating the detected position and/or orientation of the 6 DOF object to the control module;
wherein the control module is configured to:
determine the specified perspective based on the information indicating the detected position and/or orientation;
determine the specified region of the physical specimen for image capture based on the specified perspective; and
send information indicating the specified region and the specified perspective to the imaging microscopy system, thereby controlling capture of the image by the image capture subsystem of the imaging microscopy system based on the specified region and the specified perspective;
wherein the information indicating the specified region and the specified perspective is useable by the imaging microscopy system to capture an image of the specimen and to display the image on the display device.

2. The imaging microscopy control system of claim 1,
wherein the image of the specified region of the specimen staged physical specimen comprises a stereo image;
wherein the display device comprises a stereo display device;
wherein the image capture subsystem comprises a stereo image capture subsystem; and
wherein said controlling capture of the image comprises controlling capture of the stereo image by the stereo image capture subsystem of the imaging microscopy system based on the specified region and the specified perspective.

3. The imaging microscopy control system of claim 2, further comprising:
the stereo display device, coupled to the imaging microscopy system, and configured to display the stereo image.

4. The imaging microscopy control system of claim 3, wherein the stereo display device comprises:
a first display, configured to display the stereo image based on the specified perspective; and
a second display, configured to display the stereo image according to another perspective that is different than the specified perspective.

5. The imaging microscopy control system of claim 2, wherein the detected position and/or orientation comprises position and orientation.

6. The imaging microscopy control system of claim 2, wherein a first subset of the 6 DOFs of the 6 DOF tracking device correspond to the detected position and/or orientation, and wherein a second subset of the DOFs of the 6 DOF tracking device correspond to one or more auxiliary control parameters for the image capture subsystem, wherein the one or more auxiliary control parameters comprise one or more of:
magnification level of the imaging microscopy system;
focal plane of the imaging microscopy system;
one or more scanning parameters;
wherein the 6 DOF tracking device is further configured to detect values of the second subset of the DOFs of the 6 DOF tracking device and send information indicating the detected values to the control module;
wherein the control module is configured to:
determine the specified perspective based on the first subset of the 6 DOFs of the 6 DOF tracking device;
determine the one or more auxiliary control parameters based on the detected values of the second subset of the DOFs; and
determine the specified region based on the specified perspective and the one or more auxiliary control parameters corresponding to the second subset of the DOFs of the 6 DOF tracking device.

7. The imaging microscopy control system of claim 2, wherein the 6 DOF tracking device comprises a head tracking device.

8. The imaging microscopy control system of claim 2, wherein the 6 DOF object comprises one or more of:
a user's head;
the user's eyes;
one or more of the user's hands
one or more of the user's fingers; or
a hand-held stylus.

9. The imaging microscopy control system of claim 2, wherein the 6 DOF tracking device comprises a hand held direct interaction device.

10. The imaging microscopy control system of claim 2, said controlling the specimen's position and/or orientation relative to an image capture subsystem of the imaging microscopy system comprises controlling one or more of:
position and/or orientation of the specimen stage;
position and/or orientation of one or more sensors of the image capture subsystem;
incident beam geometry of the imaging microscopy system; or
position and/or orientation of a microscope scan head of the imaging microscopy system with respect to the specimen stage, wherein the specimen stage is stationary.

11. The imaging microscopy control system of claim 2, wherein the 6 DOF tracking device is further configured to:
detect at least one subsequent position and/or orientation of the 6 DOF object with respect to the stereo display device of the imaging microscopy system, wherein the at least one subsequent position and/or orientation of the 6 DOF object corresponds to at least one subsequent perspective for image capture of the specimen; and
send information indicating the detected at least one subsequent position and/or orientation of the 6 DOF object to the control module;
wherein the control module is further configured to:
determine at least one subsequent specified perspective based on the information indicating the detected at least one subsequent position and/or orientation;
determine at least one subsequent specified region of the physical specimen for stereo image capture based on the at least one subsequent specified perspective; and
send information indicating the at least one subsequent specified region and the at least one subsequent specified perspective to the imaging microscopy system, thereby controlling capture of at least one subsequent stereo image by the image capture subsystem of the imaging microscopy system based on the at least one subsequent specified region and the at least one subsequent specified perspective, thereby implementing real time navigation with respect to the specimen.

12. The imaging microscopy control system of claim 11, wherein the specified perspective is a first oblique perspective and wherein the at least one subsequent specified perspective is a second oblique perspective.

13. The imaging microscopy control system of claim 2,
wherein the position and/or orientation of the 6 DOF object is determined using camera triangulation.

14. The imaging microscopy control system of claim 2, wherein the display device comprises an obliquely positioned display.

15. The imaging microscopy control system of claim 2, wherein the imaging microscopy system utilizes one or more of multi-spectrum light, laser, electron beams, or ion beams to image the specimen.

16. The imaging microscopy control system of claim 2,
wherein capture of the stereo image by the image capture subsystem of the imaging microscopy system comprises capture of a stereo pair of images for display on the stereo display device;
wherein the control module is further configured to:
provide a specified interpupillary distance (IPD) that defines a spatial separation between two stereo views corresponding to the stereo pair of images for viewing by a user, thereby controlling capture of the stereo pair of images in accordance with the determined IPD.

17. The imaging microscopy control system of claim 16, wherein the control module is configured to adjust the IPD based on a specified magnification level of the image capture subsystem.

18. The imaging microscopy control system of claim 16, wherein the control module is configured to control capture of the stereo pair of images such that the captured stereo pair of images share a common parallax plane.

19. The imaging microscopy control system of claim 2, wherein capture of the stereo image by the image capture subsystem of the imaging microscopy system comprises capture of a stereo pair of images for display on the stereo display device, and wherein the specimen stage of the imaging microscopy system comprises a eucentric stage.

20. The imaging microscopy control system of claim 2, wherein capture of the stereo image by the image capture subsystem of the imaging microscopy system comprises capture of a stereo pair of images for display on the stereo display device, and wherein the image capture subsystem is configured to capture the stereo pair of images concurrently.

21. The imaging microscopy control system of claim 2, wherein capture of the stereo image by the image capture subsystem of the imaging microscopy system comprises capture of a stereo pair of images for display on the stereo display device, and wherein the image capture subsystem is configured to capture the stereo pair of images consecutively.

22. The imaging microscopy control system of claim 21, wherein the imaging microscopy system is configured to:
utilize an electron or ion beam to image the specimen; and
deflect the electron or ion beam using scan coils to shift the center of the raster scan from a first position whereby a first image of the stereo pair of images is captured, to a second position whereby a second image of the stereo pair of images is captured.

23. A method for controlling an imaging microscopy system, comprising:
providing a control module, coupled to an imaging microscopy system, wherein the imaging microscopy system is configured to capture an image of a specified region of a specimen staged physical specimen based on a specified perspective by controlling the specimen's position and/or orientation relative to an image capture subsystem of the imaging microscopy system corresponding to the specified perspective;
providing a 6 degree of freedom (DOF) tracking device, coupled to the control module;
detecting, via the 6 DOF tracking device, position and/or orientation of a 6 DOF object with respect to a display device of the imaging microscopy system, wherein the position and/or orientation of the 6 DOF object corresponds to a perspective for image capture of the specimen; and
sending, by the 6 DOF tracking device, information indicating the detected position and/or orientation of the 6 DOF object to the control module;
determining, by the control module, the specified perspective based on the information indicating the detected position and/or orientation;
determining, by the control module, the specified region of the physical specimen for image capture based on the specified perspective; and
sending, by the control module, information indicating the specified region and the specified perspective to the imaging microscopy system, thereby controlling capture of the image by the image capture subsystem of the imaging microscopy system based on the specified region and the specified perspective, wherein the information indicating the specified region and the specified perspective is useable by the imaging microscopy system to capture an image of the specimen; and
displaying the image on the display device.

24. A non-transitory computer accessible memory medium that stores program instructions executable by a processor to control an imaging microscopy system, wherein the imaging microscopy system is configured to capture an image of a specified region of a specimen staged physical specimen based on a specified perspective by controlling the specimen's position and/or orientation relative to an image capture subsystem of the imaging microscopy system corresponding to the specified perspective, wherein to control an imaging microscopy system, the program instructions are executable to implement:
receiving information from a 6 degree of freedom (DOF) tracking device, wherein the information indicating a detected position and/or orientation of a 6 DOF object with respect to a display device of the imaging microscopy system, wherein the position and/or orientation of the 6 DOF object corresponds to a perspective for image capture of the specimen; and
determining the specified perspective based on the information indicating the detected position and/or orientation;
determining the specified region of the physical specimen for image capture based on the specified perspective; and
sending information indicating the specified region and the specified perspective to the imaging microscopy system, thereby controlling capture of the image by the image capture subsystem of the imaging microscopy system based on the specified region and the specified perspective;
wherein the information indicating the specified region and the specified perspective is useable by the imaging microscopy system to capture an image of the specimen and to display the image on the display device.
